(19) United States
(12) Patent Application Publication
(10) Pub. No.: US 2011/0187671 A1
(43) Pub. Date: Aug. 4, 2011

(54) TOUCH-SENSITIVE LIQUID CRYSTAL MODULE AND INTEGRATED TOUCH-SENSITIVE SUBSTRATE THEREOF

(75) Inventor: Kai-Hung Huang, Xinzhuang City (TW)

(73) Assignee: CHUNGHWA PICTURE TUBES, LTD., Padeh City (TW)

(21) Appl. No.: 12/836,410

(22) Filed: Jul. 14, 2010

(30) Foreign Application Priority Data
Feb. 4, 2010 (TW) 099103321

(51) Int. Cl. G06F 3/041

(52) U.S. Cl. 345/174

(57) ABSTRACT

An integrated touch-sensitive substrate including a transparent substrate, an active component array, and a sensing array is provided. The sensing array is disposed between the active component array and the transparent substrate, and includes a plurality of sensing pads, a plurality of wires, an insulation layer, and a plurality of conductive connecting pieces. The insulation layer is located between the wires and the sensing pads. The sensing pads are all located between the insulation layer and the transparent substrate. The conductive connecting pieces are all located in the insulation layer and connected between some of the sensing pads and the wires. In addition, a touch-sensitive liquid crystal module including the integrated touch-sensitive substrate is also provided.

### CROSS-REFERENCE TO RELATED APPLICATION

This application claims the benefit of Taiwan Patent Application No. 099103321, filed on Feb. 4, 2010, which is hereby incorporated by reference for all purposes as if fully set forth herein.

### BACKGROUND OF THE INVENTION

1. Field of Invention

The present invention relates to a liquid crystal display (LCD), and more particularly to a touch-sensitive liquid crystal module and an integrated touch-sensitive substrate thereof.

2. Related Art

A touch-sensitive liquid crystal display (LCD) is an LCD having functions of both image display and data input. Currently, many electronic equipments, for example, handheld electronic devices such as mobile phones and personal digital assistants (PDAs) as well as computers, have touch-sensitive LCDs installed therein. Thus, the touch-sensitive LCD has currently been widely used in the society.

The touch-sensitive LCD includes a touch-sensitive liquid crystal module as a main component. The touch-sensitive liquid crystal module generally includes a liquid crystal module, a touch-sensitive substrate, and a cover lens. The touch-sensitive substrate is disposed between the liquid crystal module and the cover lens, and is bonded to the cover lens and the liquid crystal module through an adhesive.

In addition, the liquid crystal module includes a liquid crystal panel, a backlight module, and a liquid crystal layer located between the liquid crystal panel and the backlight module. The touch-sensitive substrate is usually installed on a color filter substrate of the liquid crystal panel.

In the process of bonding the liquid crystal module, the touch-sensitive substrate, and the cover lens together, the three parts must be aligned with each other, so that their positions relative to each other are correct. Meanwhile, bubbles cannot be generated between the liquid crystal module and the touch-sensitive substrate as well as between the touch-sensitive substrate and the cover lens. Otherwise, it results in color non-uniformity, such as mura, in the picture, thereby deteriorating the picture quality of the touch-sensitive LCD.

However, both the liquid crystal module and the touch-sensitive substrate are usually manufactured of glass substrates. Thus, the liquid crystal module, the touch-sensitive substrate, and the cover lens are quite rigid, so that it is difficult to evenly bond the touch-sensitive substrate to the liquid crystal module and the cover lens during the bonding process. As a result, bubbles easily occur between the liquid crystal module and the touch-sensitive substrate as well as between the touch-sensitive substrate and the cover lens, and the yield of the current touch-sensitive LCD is low.

Further, after the touch-sensitive liquid crystal module is completed by bonding the liquid crystal module, the touch-sensitive substrate, and the cover lens together, once the completed touch-sensitive liquid crystal module is found defective, for example, a serious mismatch is resulted from misalignment between the liquid crystal module, the touch-sensitive substrate, and the cover lens, or bubbles occur in the touch-sensitive liquid crystal module, it is difficult to disassemble the defective touch-sensitive liquid crystal module for rework.

In detail, since the liquid crystal module, the touch-sensitive substrate, and the cover lens are bonded to each other through the adhesive, and they are quite rigid, if the defective touch-sensitive liquid crystal module is disassembled forcibly, the residual adhesive difficult to be removed remains on the liquid crystal module, the touch-sensitive substrate, and the cover lens. Moreover, the liquid crystal module, the touch-sensitive substrate, or the cover lens is probably cracked due to improper force application in the disassembly. Therefore, the defective touch-sensitive liquid crystal modules completed due to bonding failure are most likely discarded now.

### SUMMARY OF THE INVENTION

The present invention is directed to an integrated touch-sensitive substrate including an active component array capable of driving liquid crystal molecules.

The present invention is directed to a touch-sensitive liquid crystal module including the aforementioned integrated touch-sensitive substrate.

The present invention provides an integrated touch-sensitive substrate including a transparent substrate, an active component array, and a sensing array. The sensing array is disposed between the active component array and the transparent substrate, and includes a plurality of sensing pads, a plurality of wires, an insulation layer, and a plurality of conductive connecting pieces. The insulation layer is located between the wires and the sensing pads. The sensing pads are all located between the insulation layer and the transparent substrate. The conductive connecting pieces are all located in the insulation layer and connected between some of the sensing pads and the wires.

The present invention also provides a touch-sensitive liquid crystal module including the integrated touch-sensitive substrate, an opposite substrate, a liquid crystal layer, and a backlight source. The liquid crystal layer is disposed between the opposite substrate and the integrated touch-sensitive substrate, and the opposite substrate is located between the integrated touch-sensitive substrate and the backlight source.

In view of the above, the integrated touch-sensitive substrate of the present invention includes an active component array and a sensing array, and the active component array is capable of driving liquid crystal molecules in a liquid crystal layer, so the touch-sensitive liquid crystal module of the present invention has functions of image display and data input at the same time.

In order to make the aforementioned features and advantages of the present invention more comprehensible, embodiments accompanied with figures are described in detail below.

### BRIEF DESCRIPTION OF THE DRAWINGS

The present invention will become more fully understood from the detailed description given herein below for illustration only, and thus are not limitative of the present invention, and wherein;

FIG. 1A is a schematic top view of a touch-sensitive liquid crystal module according to an embodiment of the present invention;

FIG. 1B is a schematic cross-sectional view along line I-I in FIG. 1A;

FIG. 2 is a schematic cross-sectional view of a touch-sensitive liquid crystal module according to another embodiment of the present invention;

FIG. 3 is a schematic cross-sectional view of a touch-sensitive liquid crystal module according to another embodiment of the present invention;

FIG. 4 is a schematic cross-sectional view of a touch-sensitive liquid crystal module according to another embodiment of the present invention; and

FIG. 5 is a schematic cross-sectional view of a touch-sensitive liquid crystal module according to another embodiment of the present invention.

### DETAILED DESCRIPTION OF THE INVENTION

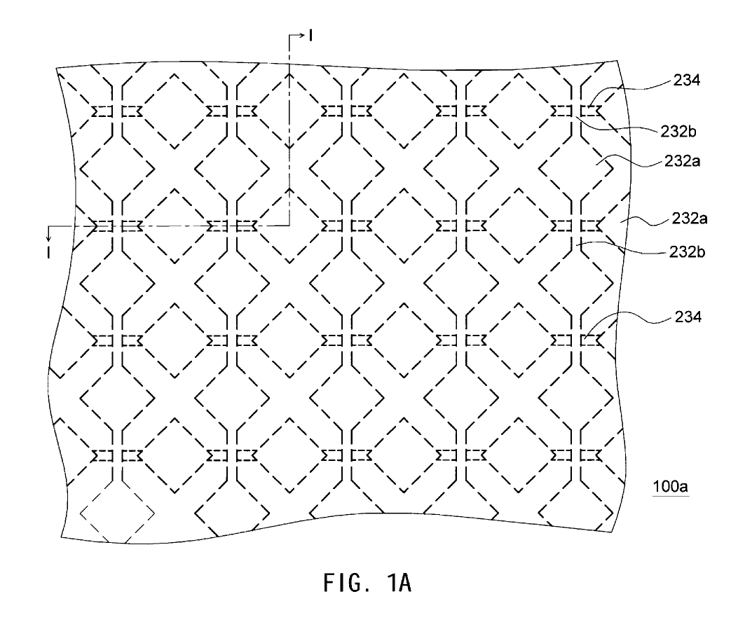

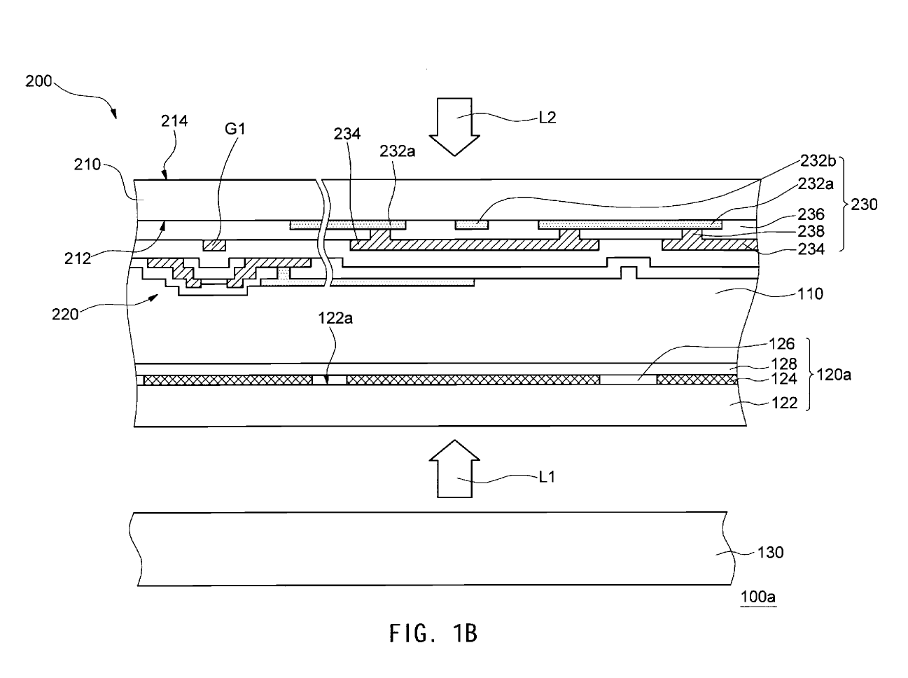

FIG. 1A is a schematic top view of a touch-sensitive liquid crystal module according to an embodiment of the present invention, and FIG. 1B is a schematic cross-sectional view along line I-I in FIG. 1A. Referring to FIGS. 1A and 1B, the touch-sensitive liquid crystal module 100a of this embodiment includes an integrated touch-sensitive substrate 200, a liquid crystal layer 110, an opposite substrate 120a, and a backlight source 130. The liquid crystal layer 110 is disposed between the opposite substrate 120a and the integrated touch-sensitive substrate 200, and the opposite substrate 120a is located between the integrated touch-sensitive substrate 200 and the backlight source 130.

The backlight source 130 may be a plane light source, and the backlight source 130 may be a backlight module, such as a direct-type backlight module or a side-type backlight module. The backlight source 130 can emit a light L1 towards the opposite substrate 120a. The integrated touch-sensitive substrate 200, the liquid crystal layer 110, and the opposite substrate 120a all have light transmittance, so that the light L1 sequentially passes through the opposite substrate 120a, the liquid crystal layer 110, and the integrated touch-sensitive substrate 200, so as to enable the touch-sensitive liquid crystal module 100a to display image.

The opposite substrate 120a may be a color filter substrate and include a substrate 122, a black matrix layer 124, a color filter pattern layer 126, and a common electrode 128. The black matrix layer 124 and the color filter pattern layer 126 are both disposed between the substrate 122 and the common electrode 128, and the common electrode 128 is located opposite to the integrated touch-sensitive substrate 200.

The black matrix layer 124 can block the light L1, that is, the light L1 substantially cannot pass through the black matrix layer 124. The black matrix layer 124 may be net-shaped, and the color filter pattern layer 126 may be located in lattices of the black matrix layer 124. The substrate 122 has a plane 122a, and the black matrix layer 124 and the color filter pattern layer 126 are both located on the plane 122a and both in contact with the substrate 122.

The integrated touch-sensitive substrate 200 includes a transparent substrate 210, an active component array 220, and a sensing array 230. The sensing array 230 is disposed between the active component array 220 and the transparent substrate 210, and includes a plurality of sensing pads 232a, a plurality of wires 234, and an insulation layer 236. The insulation layer 236 is located between the wires 234 and the sensing pads 232a. The sensing pads 232a are all located between the insulation layer 236 and the transparent substrate 210, and the wires 234 are located between the active component array 220 and the insulation layer 236.

Among all of the sensing pads 232a, some of the sensing pads 232a are electrically connected to each other, and other sensing pads 232a are electrically connected to each other. For example, in FIGS. 1A and 1B, the sensing pads 232a are arranged in a matrix, in which the sensing pads 232a in each column are electrically connected to each other, and the sensing pads 232a in each row are electrically connected to each other, but the sensing pads 232a in each column and the sensing pads 232a in each row are not electrically conducted.

In detail, the sensing array 230 further includes a plurality of traces 232b and a plurality of conductive connecting pieces 238. The conductive connecting pieces 238 are all located in the insulation layer 236 and connected between some of the sensing pads 232a and the wires 234. For example, in this embodiment, the conductive connecting pieces 238 are connected to the sensing pads 232a in each row and the wires 234, as shown in FIGS. 1A and 1B.

The traces 232b are all located between the insulation layer 236 and the transparent substrate 210. The traces 232b and the sensing pads 232a may be located on the same plane of the transparent substrate 210. For example, the traces 232b and the sensing pads 232a are both located on a plane 212 of the transparent substrate 210. The traces 232b are connected to the others of the sensing pads 232a, and the sensing pads 232a to which the traces 232b connect are not connected to the conductive connecting pieces 238. Besides, in this embodiment, each of the traces 232b is connected between two adjacent sensing pads 232a, as shown in FIG. 1A.

Through the conductive connecting pieces 238, the wires 234, and the traces 232b, some of the sensing pads 232a are electrically connected to each other, and the others are electrically connected to each other. That is, the sensing pads 232a in each column are electrically connected to each other through the traces 232b, and the sensing pads 232a in each row are electrically connected to each other through the conductive connecting pieces 238 and the wires 234.

In this embodiment, the materials of the sensing pads 232a and the traces 232b may be a transparent conductive material, such as indium tin oxide (ITO) or indium zinc oxide (IZO). The material of the wires 234 may be metal or the transparent conductive material. In other words, the wires 234 may be a plurality of metal lines or a plurality of transparent conductive lines.

In addition, the wires 234 may also have a double-layer structure of chromium oxide/chromium. That is, the wires 234 may be formed by a stack of a chromium oxide layer and a chromium metal layer, in which the chromium oxide layer is located between the chromium metal layer and the insulation layer 236. The light reflectivity of the chromium oxide layer may be less than 7%, and thus the chromium oxide layer has the very low light reflectivity.

When an incident light L2 enter to the wires 234 having the double-layer structure of chromium oxide/chromium from the transparent substrate 210, the chromium oxide layer of the wires 234 may effectively absorb the incident light L2 to reduce the reflection of the incident light L2 caused by the touch-sensitive liquid crystal module 100a, thereby reducing the adverse effect of the reflected incident light L2 to the image displayed by the touch-sensitive liquid crystal module 100a.

The insulation layer 236 may be an inorganic layer, for example, a silicon nitride (SiN_{X}) layer, or an organic layer, for example, a high molecular material layer such as an organic photoresist layer. Generally speaking, the organic photoresist layer has a low dielectric constant. Therefore, when the insulation layer 236 is an organic photoresist layer, the insulation layer 236 may reduce the interference of the active component array 220 to the sensing array 230 in operation, so as to increase the sensitivity of the integrated touch-sensitive substrate 200.

The active component array 220 is capable of driving liquid crystal molecules in the liquid crystal layer 110, and may be a bottom-gate transistor array having a plurality of gates G1 (with only one shown in FIG. 1B). The gates G1 and the wires 234 may be formed of the same film, for example, formed by performing lithography and etching on the same metal layer. The gates G1 and the wires 234 formed by lithography and etching may be fabricated with the same mask. In this manner, the number of the used masks can be reduced, so as to reduce the manufacturing cost.

Based on the above, when a touch-sensitive pen or a finger contacts the other plane 214 of the transparent substrate 210, the capacitance value of the sensing pads 232a corresponding to the touch-sensitive pen or the finger is changed. Then, the touch-sensitive liquid crystal module 100a controls a handheld electronic device (for example, a mobile phone or a PDA), a computer, or the like according to the changed capacitance value. For example, move a cursor displayed on a screen of the electronic equipment. Hence, a user can operate the electronic equipment through the touch-sensitive liquid crystal module 100a.

In addition, the sensing array 230 is disposed between the active component array 220 and the transparent substrate 210, and the transparent substrate 210 can protect the sensing array 230 from being scratched. Thus, the transparent substrate 210 can not only bear the sensing array 230 and the active component array 220, but also be suitable as a cover lens of the touch-sensitive liquid crystal module 100a. Hence, the touch-sensitive liquid crystal module 100a of this embodiment does not need to have an additional cover lens bonded thereof.

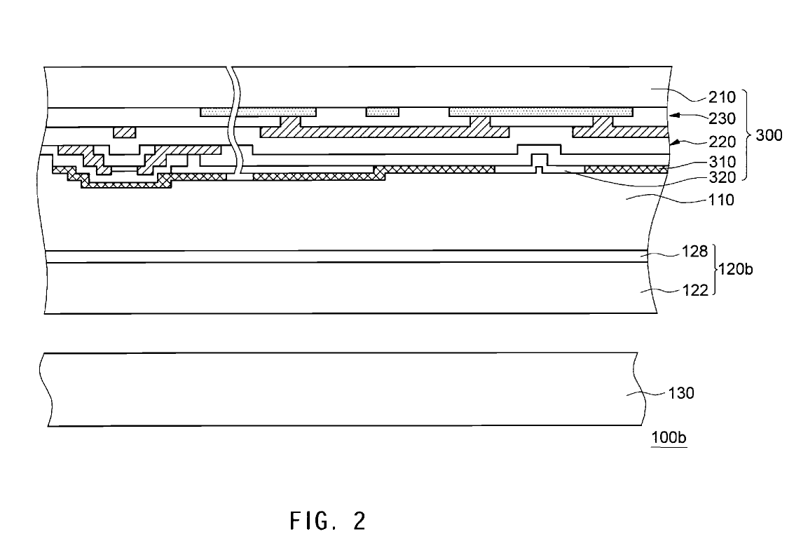

FIG. 2 is a schematic cross-sectional view of a touch-sensitive liquid crystal module according to another embodiment of the present invention. Referring to FIG. 2, the touch-sensitive liquid crystal module 100b of this embodiment includes an integrated touch-sensitive substrate 300, a liquid crystal layer 110, an opposite substrate 120b, and a backlight source 130. The liquid crystal layer 110 is disposed between the opposite substrate 120b and the integrated touch-sensitive substrate 300, and the opposite substrate 120b is located between the integrated touch-sensitive substrate 300 and the backlight source 130.

The touch-sensitive liquid crystal module 100b of this embodiment and the touch-sensitive liquid crystal module 100a of the aforementioned embodiment have the same function and similar structures. Thus, the differences between the touch-sensitive liquid crystal modules 100a and 100b will be mainly introduced below without repeating the same features thereof.

In detail, as a difference from the aforementioned embodiment, although the opposite substrate 120b shown in FIG. 2 includes a substrate 122 and a common electrode 128 disposed on the opposite substrate 120b, the opposite substrate 120b does not include any black matrix or color filter pattern layer, that is, the opposite substrate 120b shown in FIG. 2 is not a color filter substrate, and the integrated touch-sensitive substrate 300 not only includes a transparent substrate 210, an active component array 220, and a sensing array 230, but also includes a black matrix layer 310 and a color filter pattern layer 320.

In particular, the black matrix layer 310 partially covers the active component array 220, and the active component array 220 is located between the black matrix layer 310 and the transparent substrate 210. The color filter pattern layer 320 also partially covers the active component array 220, and the active component array 220 is located between the color filter pattern layer 320 and the transparent substrate 210. The black matrix layer 310 and the color filter pattern layer 320 are both located opposite to the common electrode 128 of the opposite substrate 120b. In addition, the black matrix layer 310 may be net-shaped, and the color filter pattern layer 320 may be located in lattices of the black matrix layer 310.

It should be noted that, although the black matrix layer 310 and the color filter pattern layer 320 in FIG. 2 both cover the active component array 220, in other embodiments, only one of the black matrix layer 310 and the color filter pattern layer 320 covers the active component array 220, while the other is disposed between the substrate 122 and the common electrode 128, that is, the opposite substrate 120b or the integrated touch-sensitive substrate 300 does not include both the black matrix layer 310 and the color filter pattern layer 320.

For example, in other embodiments, the black matrix layer 310 may cover the active component array 220, while the color filter pattern layer 320 is disposed between the substrate 122 and the common electrode 128. That is, the opposite substrate 120b may be a color filter substrate without the black matrix layer 310, or the color filter pattern layer 320 may cover the active component array 220, and the black matrix layer 310 is disposed between the substrate 122 and the common electrode 128.

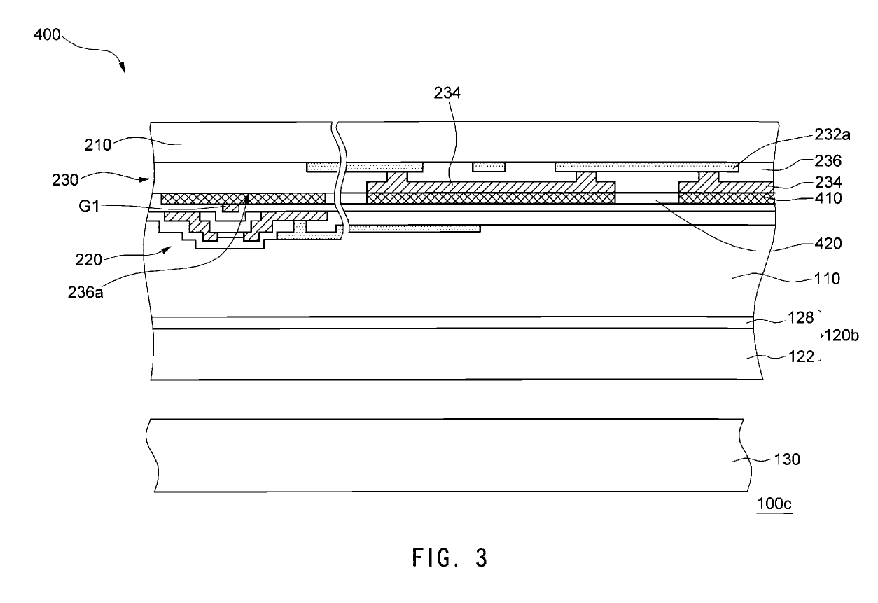

FIG. 3 is a schematic cross-sectional view of a touch-sensitive liquid crystal module according to another embodiment of the present invention. Referring to FIG. 3, the touch-sensitive liquid crystal module 100c of this embodiment includes an integrated touch-sensitive substrate 400, a liquid crystal layer 110, an opposite substrate 120b, and a backlight source 130. The liquid crystal layer 110 is disposed between the opposite substrate 120b and the integrated touch-sensitive substrate 400, and the opposite substrate 120b is located between the integrated touch-sensitive substrate 400 and the backlight source 130.

The touch-sensitive liquid crystal module 100c of this embodiment and the touch-sensitive liquid crystal module 100b shown in FIG. 2 have the same function and similar structures, and the difference lies in that: the integrated touch-sensitive substrate 400 of the touch-sensitive liquid crystal module 100c is different from the integrated touch-sensitive substrate 300 in FIG. 2 in structure. The difference between the integrated touch-sensitive substrates 300 and 400 will be mainly introduced below.

In the embodiment shown in FIG. 3, the integrated touch-sensitive substrate 400 also includes some components of the integrated touch-sensitive substrate 300. In particular, the integrated touch-sensitive substrate 400 also includes a transparent substrate 210, an active component array 220, and a sensing array 230. The sensing array 230 is also disposed between the active component array 220 and the transparent substrate 210.

The integrated touch-sensitive substrate 400 further includes a black matrix layer 410 and a color filter pattern layer 420. However, as a difference from the integrated touch-sensitive substrate 300 shown in FIG. 2, the black matrix layer 410 and the color filter pattern layer 420 in this embodiment are located at completely different positions from those of the black matrix layer 310 and the color filter pattern layer 320.

Specifically, in the embodiment shown in FIG. 3, the black matrix layer 410 and the color filter pattern layer 420 are both located between the transparent substrate 210 and the active component array 220, and are further located between the active component array 220 and an insulation layer 236 of the sensing array 230. Therefore, the gates G1 of the active component array 220 are disposed on the black matrix layer 410 instead of a surface 236a of the insulation layer 236.

A plurality of wires 234 of the sensing array 230 are located between the black matrix layer 410 and the sensing pads 232a, and the insulation layer 236 is located between the wires 234 and the sensing pads 232a. Hence, the wires 234 are sandwiched between the insulation layer 236 and the black matrix layer 410. Since the gates G1 of the active component array 220 are disposed on the black matrix layer 410 instead of the surface 236a, that is, the gates G1 and the wires 234 are respectively disposed on two opposite sides of the black matrix layer 410, in this embodiment, the gates G1 and the wires 234 are difficult to be formed of the same film and thus difficult to be fabricated with only one mask.

Although the integrated touch-sensitive substrate 400 includes both the black matrix layer 410 and the color filter pattern layer 420 in the embodiment shown in FIG. 3, in other embodiments, the black matrix layer 410 and the color filter pattern layer 420 may be alternatively disposed between the substrate 122 and the common electrode 128, and the integrated touch-sensitive substrate 400 may include only the black matrix layer 410 or the color filter pattern layer 420 alternatively.

For example, the integrated touch-sensitive substrate 400 may include the color filter pattern layer 420 only, and the black matrix layer 410 is disposed between the substrate 122 and the common electrode 128; or, the integrated touch-sensitive substrate 400 may include the black matrix layer 410 only, and the color filter pattern layer 420 is disposed between the substrate 122 and the common electrode 128. Therefore, the black matrix layer 410 and the color filter pattern layer 420 shown in FIG. 3 are merely an example for illustration, but do not limit the present invention.

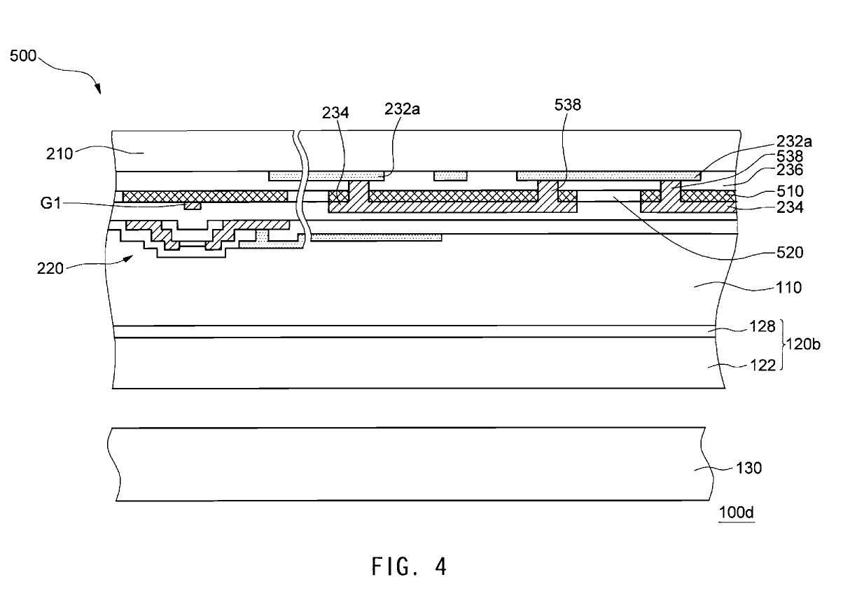

FIG. 4 is a schematic cross-sectional view of a touch-sensitive liquid crystal module according to another embodiment of the present invention. Referring to FIG. 4, the touch-sensitive liquid crystal module 100d of this embodiment and the touch-sensitive liquid crystal module 100c of the aforementioned embodiment have the same function and similar structures. Therefore, the difference between the two modules is mainly introduced below without repeating the same features thereof.

In detail, the difference between the touch-sensitive liquid crystal module 100d and the touch-sensitive liquid crystal module 100c lies in that: in an integrated touch-sensitive substrate 500 of the touch-sensitive liquid crystal module 100d, a black matrix layer 510 and a color filter pattern layer 520 are both located between the wires 234 and an insulation layer 236, that is, the wires 234 are disposed on the black matrix layer 510. A plurality of conductive connecting pieces 538 pass through the insulation layer 236 and the black matrix layer 510 and are connected between some of the sensing pads 232a and the wires 234.

The black matrix layer 510 and the color filter pattern layer 520 are both located between a transparent substrate 210 and an active component array 220, and are both also located between the insulation layer 236 and the active component array 220. Hence, the gates G1 of the active component array 220 are also disposed on the black matrix layer 510, and the gates G1 and the wires 234 are located on the same surface of the black matrix layer 510. Therefore, in this embodiment, the gates G1 and the wires 234 may be formed of the same film, and may also be fabricated with the same mask.

Although the integrated touch-sensitive substrate 500 includes both the black matrix layer 510 and the color filter pattern layer 520 in the embodiment shown in FIG. 4, in other embodiments, the integrated touch-sensitive substrate 500 may include the color filter pattern layer 520 only, and the black matrix layer 510 is disposed between a substrate 122 and a common electrode 128 of an opposite substrate 120b; or the integrated touch-sensitive substrate 500 may include the black matrix layer 510 only, and the color filter pattern layer 520 is disposed between the substrate 122 and the common electrode 128. Therefore, the black matrix layer 510 and the color filter pattern layer 520 shown in FIG. 4 are merely an example for illustration, but do not limit the present invention.

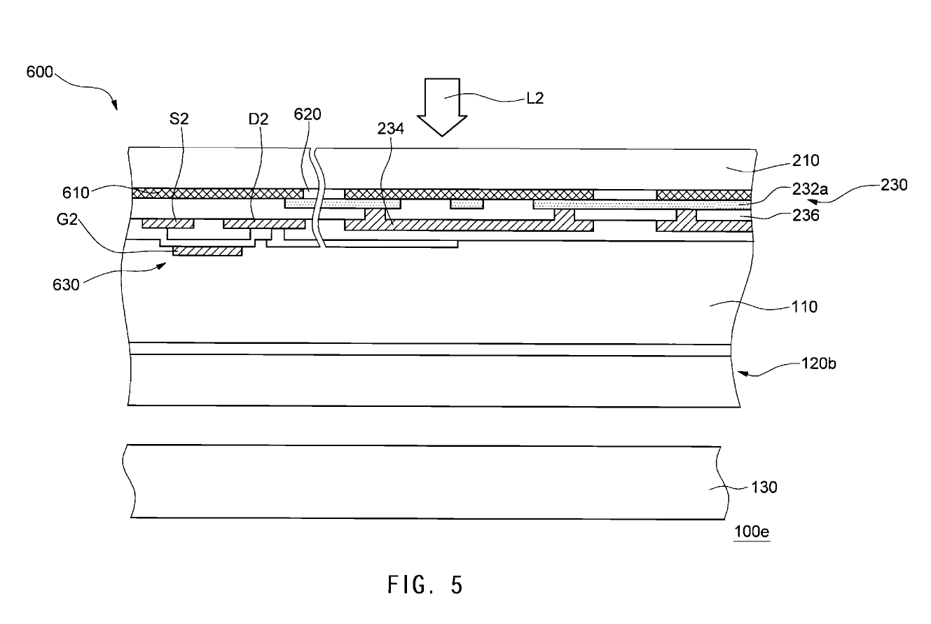

FIG. 5 is a schematic cross-sectional view of a touch-sensitive liquid crystal module according to another embodiment of the present invention. Referring to FIG. 5, the touch-sensitive liquid crystal module 100e of this embodiment includes an integrated touch-sensitive substrate 600, a liquid crystal layer 110, an opposite substrate 120b, and a backlight source 130. The liquid crystal layer 110 is dispose between the opposite substrate 120b and the integrated touch-sensitive substrate 600, and the opposite substrate 120b is located between the integrated touch-sensitive substrate 600 and the backlight source 130.

The touch-sensitive liquid crystal module 100e of this embodiment is the same as the touch-sensitive liquid crystal modules 100a to 100d of the above embodiments in function. However, in terms of structure, the touch-sensitive liquid crystal module 100e is different from the touch-sensitive liquid crystal modules 100a to 100d. The differences lie in that: an active component array 630 included in the integrated touch-sensitive substrate 600 is a top-gate transistor array, and a black matrix layer 610 and a color filter pattern layer 620 of the integrated touch-sensitive substrate 600 are located at different positions from those in the embodiments in FIGS. 1B to 4.

In detail, the active component array 630 has a plurality of gates G2, a plurality of sources S2, and a plurality of drains D2. The sources S2 and the drains D2 are both located between the gates G2 and a transparent substrate 210 of the integrated touch-sensitive substrate 600. In addition, the integrated touch-sensitive substrate 600 further includes a sensing array 230. The sources S2, the drains D2, and a plurality of wires 234 of the sensing array 230 may be formed of the same film, for example, fabricated with the same mask.

The black matrix layer 610 and the color filter pattern layer 620 are both located between an insulation layer 236 and the transparent substrate 210, and are further located between the sensing pads 232a and the transparent substrate 210. The black matrix layer 610 may be net-shaped, and the color filter pattern layer 620 may be located in lattices of the black matrix layer 610. The black matrix layer 610 is corresponding to the gates G2, so that the incident light L2 does not directly shine on the gates G2 from the transparent substrate 210. In this manner, a photo leakage current generated by the active component array 630 can be reduced, so as to enable the active component array 630 to normally drive the liquid crystal molecules in the liquid crystal layer 110.

It should be noted that, the active component array 630 in this embodiment is a top-gate transistor array, but in other embodiments, the active component array 630 may be replaced with a bottom-gate transistor array. That is, the active component array 630 in FIG. 5 may be replaced with the active component array 220.

In addition, the top-gate transistor array may also be applied in the aforementioned touch-sensitive liquid crystal modules 100a to 100d. That is to say, the active component array 220 in FIG. 1B and FIGS. 2 to 4 may be replaced with the active component array 630. Therefore, the active component arrays 220 and 630 in FIG. 1B and FIGS. 2 to 5 are merely an example for illustration, but do not limit the present invention.

In view of the above, since the integrated touch-sensitive substrate of the present invention includes an active component array and a sensing array, the touch-sensitive liquid crystal module of the present invention has functions of image display and data input at the same time. In addition, the integrated touch-sensitive substrate of the present invention can be manufactured by using the current manufacturing technology for an active component array substrate. As compared with the prior art, the present invention does not need to use the adhesive to manufacture the integrated touch-sensitive substrate and solve the problem of bubble generation.

Further, the transparent substrate included in the integrated touch-sensitive substrate can not only bear the sensing array and the active component array, but also be suitable as a cover lens. Therefore, the transparent substrate can protect the sensing array from being scratched. Based on the above, neither of the touch-sensitive liquid crystal module and the integrated touch-sensitive substrate of the present invention need to have a cover lens bonded, so that the present invention can effectively solve the problem of reduced yield due to the bonding of the cover lens in the prior art and thus effectively increase the yield of the touch-sensitive LCD.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An integrated touch-sensitive substrate, comprising:
a transparent substrate;
an active component array; and
a sensing array, disposed between the active component array and the transparent substrate, and comprising a plurality of sensing pads, a plurality of wires, an insulation layer, and a plurality of conductive connecting pieces, wherein the insulation layer is located between the wires and the sensing pads, the sensing pads are all located between the insulation layer and the transparent substrate, and the conductive connecting pieces are all located in the insulation layer and connected between some of the sensing pads and the wires.

2. The integrated touch-sensitive substrate according to claim 1, wherein the sensing array further comprises a plurality of traces all located between the insulation layer and the transparent substrate and connected to the others of the sensing pads.

3. The integrated touch-sensitive substrate according to claim 1, wherein the wires have a double-layer structure of chromium oxide/chromium.

4. The integrated touch-sensitive substrate according to claim 1, wherein the insulation layer is an organic photoresist layer.

5. The integrated touch-sensitive substrate according to claim 1, further comprising a black matrix layer located between the transparent substrate and the active component array.

6. The integrated touch-sensitive substrate according to claim 5, wherein the black matrix layer is located between the insulation layer and the transparent substrate.

7. The integrated touch-sensitive substrate according to claim 5, wherein the black matrix layer is located between the insulation layer and the active component array.

8. The integrated touch-sensitive substrate according to claim 6, wherein the wires are located between the black matrix layer and the sensing pads.

9. The integrated touch-sensitive substrate according to claim 6, wherein the black matrix layer is located between the wires and the insulation layer, and the conductive connecting pieces pass through the insulation layer and the black matrix layer.

10. The integrated touch-sensitive substrate according to claim 1, further comprising a black matrix layer partially covering the active component array, wherein the active component array is located between the black matrix layer and the transparent substrate.

11. A touch-sensitive liquid crystal module, comprising:
an integrated touch-sensitive substrate, comprising:
a transparent substrate;
an active component array; and
a sensing array, disposed between the active component array and the transparent substrate, and comprising a plurality of sensing pads, a plurality of wires, an insulation layer, and a plurality of conductive connecting pieces, wherein the insulation layer is located between the wires and the sensing pads, the sensing pads are all located between the insulation layer and the transparent substrate, and the conductive connecting pieces are all located in the insulation layer and connected between the sensing pads and the wires;
an opposite substrate;
a liquid crystal layer, disposed between the opposite substrate and the integrated touch-sensitive substrate; and
a backlight source, wherein the opposite substrate is located between the integrated touch-sensitive substrate and the backlight source.

12. The touch-sensitive liquid crystal module according to claim 11, wherein the sensing array further comprises a plurality of traces all located between the insulation layer and the transparent substrate and connected to the others of the sensing pads, and each of the traces is connected between two adjacent sensing pads.

13. The touch-sensitive liquid crystal module according to claim 11, wherein the wires have a double-layer structure of chromium oxide/chromium.

14. The touch-sensitive liquid crystal module according to claim 11, wherein the insulation layer is an organic photoresist layer.

15. The touch-sensitive liquid crystal module according to claim 11, wherein the integrated touch-sensitive substrate further comprises a black matrix layer located between the transparent substrate and the active component array.

16. The touch-sensitive liquid crystal module according to claim 15, wherein the black matrix layer is located between the insulation layer and the transparent substrate.

17. The touch-sensitive liquid crystal module according to claim 15, wherein the black matrix layer is located between the insulation layer and the active component array.

18. The touch-sensitive liquid crystal module according to claim 17, wherein the wires are located between the black matrix layer and the sensing pads.

19. The touch-sensitive liquid crystal module according to claim 17, wherein the black matrix layer is located between the wires and the insulation layer, and the conductive connecting pieces pass through the insulation layer and the black matrix layer.

20. The touch-sensitive liquid crystal module according to claim 11, wherein the integrated touch-sensitive substrate further comprises a black matrix layer partially covering the active component array, and the active component array is located between the black matrix layer and the transparent substrate.
